(19) United States
(12) Patent Application Publication
(10) Pub. No.: US 2024/0217458 A1
(43) Pub. Date: Jul. 4, 2024

(54) VEHICLE MOUNTED COMMUNICATION APPARATUS AND VEHICLE MOUNTED COMMUNICATION SYSTEM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Tsuyoshi KONTANI, Yokkaichi-shi, Mie (JP); Shoki OJIMA, Yokkaichi-shi, Mie (JP)

(21) Appl. No.: 18/552,004

(22) PCT Filed: Mar. 8, 2022
(86) PCT No.: PCT/JP2022/010057

§ 371 Date: Sep. 22, 2023

(30) Foreign Application Priority Data
Mar. 24, 2021 (JP) 2021-050253

(51) Int. Cl. B60R 16/023; B60K 35/22; B60W 10/10; B60W 10/184; B60W 10/20; B60W 60/00

(52) U.S. Cl. CPC B60R 16/0231; B60K 35/22; B60W 10/10; B60W 10/184; B60W 10/20; B60W 60/005

(57) ABSTRACT

There is provided a vehicle-mounted communication apparatus and a vehicle-mounted communication system capable of reducing the number of locations where the connectors of communication lines are directly connected in a vehicle. A vehicle-mounted communication apparatus according to the present disclosure includes: a first connection unit, a second connection unit, and a third connection unit to which communication lines provided inside the vehicle are respectively connected; a communication unit configured to perform communication via the communication lines; a first communication path disposed between the first connection unit and the communication unit; a second communication path that directly connects the second connection unit and the third connection unit; and a switching unit for switching the first communication path and the second communication path between a connected state and a cut-off state.

### CROSS-REFERENCE TO RELATED APPLICATIONS

This application is the U.S. national stage of PCT/JP2022/010057 filed on Mar. 8, 2022, which claims priority of Japanese Patent Application No. JP 2021-050253 filed on Mar. 24, 2021, the contents of which are incorporated herein.

### TECHNICAL FIELD

The present disclosure relates to a vehicle-mounted communication apparatus and a vehicle-mounted communication system that perform communication via communication lines provided in a vehicle.

### BACKGROUND

Vehicles are conventionally equipped with a plurality of vehicle-mounted communication apparatuses, such as ECUs (Electronic Control Units). The plurality of vehicle-mounted communication apparatuses communicate via communication lines laid out in the vehicle. In recent years, the number of vehicle-mounted communication apparatuses installed in a vehicle has increased, resulting in increases in the number, length, and the like of the communication lines installed in the vehicle.

JP 2011-500430A proposes a communication system equipped with a first communication unit that performs communication according to a first physical protocol and a second communication unit that performs communication according to a second physical protocol. This communication system switches between a first transmission mode using the first communication unit and a second transmission mode using the second communication unit according to an agreement with a communication partner.

In a conventional vehicle, the entire area of the vehicle is divided into a plurality of areas, such as a front part, a central part, and a rear part, and communication lines laid out in the respective areas are directly connected to allow communication between the areas. A plurality of communication lines are directly connected by connecting connectors that are provided at the ends of the communication lines. In recent years, the number of communication lines installed in vehicles has increased, resulting in an increase in the number of locations where connectors are connected.

The present disclosure was conceived in view of the situation described above, and has an object of providing a vehicle-mounted communication apparatus and a vehicle-mounted communication system capable of reducing the number of locations where the connectors of communication lines are directly connected in a vehicle.

### SUMMARY

A vehicle-mounted communication apparatus according to an aspect of the present disclosure includes: a first connection unit, a second connection unit, and a third connection unit to which communication lines provided in a vehicle are respectively connected; a communication unit configured to perform communication via the communication lines; a first communication path disposed between the first connection unit and the communication unit; a second communication path that directly connects the second connection unit and the third connection unit; and a switching unit for switching between a connected state where the first communication path and the second communication path are connected and a cut-off state where the first communication path and the second communication path are cut off.

The present application can be realized not only as an apparatus with the characteristic control unit described above, but also as a method in which the characteristic processing is performed as steps, or as a computer program for causing a computer to execute such steps. Part or all of the described apparatuses can be implemented as a semiconductor integrated circuit, and/or can be implemented as another apparatus or system including such apparatuses.

### Advantageous Effects

With the above configuration, it is possible to reduce the number of locations where the connectors of communication lines are directly connected in a vehicle.

### BRIEF DESCRIPTION OF DRAWINGS

FIG. 1 is a schematic diagram for describing the configuration of a vehicle-mounted communication system according to an embodiment of the present disclosure.

FIG. 2 is a block diagram depicting the configuration of an ECU according to a first embodiment.

FIG. 3 is a flowchart depicting the procedure of processing performed by the ECU according to the first embodiment.

FIG. 4 is a table indicating examples of vehicle-mounted devices included in a first network and a second network.

FIG. 5 is a block diagram depicting the configuration of an ECU according to a second embodiment.

FIG. 6 is a flowchart depicting the procedure of processing performed by the ECU according to the second embodiment.

FIG. 7 is a block diagram depicting the configuration of an ECU according to a third embodiment.

FIG. 8 is a block diagram depicting the configuration of an ECU according to a fourth embodiment.

### DETAILED DESCRIPTION OF PREFERRED EMBODIMENTS

Modes for carrying out the present disclosure will first be listed and described in outline. At least some parts of the embodiments described below may be freely combined.

A vehicle-mounted communication apparatus according to an aspect of the present disclosure includes: a first connection unit, a second connection unit, and a third connection unit to which communication lines provided in a vehicle are respectively connected; a communication unit configured to perform communication via the communication lines; a first communication path disposed between the first connection unit and the communication unit; a second communication path that directly connects the second connection unit and the third connection unit; and a switching unit for switching between a connected state where the first communication path and the second communication path are connected and a cut-off state where the first communication path and the second communication path are cut off.

In this aspect, a vehicle-mounted communication apparatus to be installed in a vehicle includes: a first connection unit, a second connection unit, and a third connection unit to which communication lines are respectively connected; and a communication unit configured to perform communication via the communication lines with vehicle-mounted devices connected to these connection units. A first communication path disposed between the first connection unit and the communication unit and a second communication path that directly connects the second connection unit and the third connection unit are provided inside the vehicle-mounted communication apparatus. The vehicle-mounted communication apparatus is equipped with a switching unit for switching between a connected state where the first communication path and the second communication path are connected and a cut-off state where the first communication path and the second communication path are cut off.

By connecting two communication lines, whose connectors would be directly connected in a conventional vehicle, to the second connection unit and the third connection unit of the vehicle-mounted communication apparatus, such communication lines become connected via the second communication path of the vehicle-mounted communication apparatus. By doing so, it is possible to construct a communication network in a vehicle by connecting communication lines via the vehicle-mounted communication apparatus instead of directly connecting the communication lines together.

By placing the first communication path and the second communication path in the connected state using the switching unit, it is possible for the vehicle-mounted communication apparatus to transmit and receive signals relating to communication between the three communication lines connected to the first connection unit, the second connection unit, and the third connection unit. By doing so, it is possible for vehicle-mounted devices connected to these three communication lines to communicate with each other. In addition, by placing the first communication path and the second communication path in the cut-off state using the switching unit, it becomes no longer possible to transmit and receive signals relating to communication between the communication line connected to the first connection unit and the two communication lines connected to the second connection unit and the third connection unit. By configuring the vehicle-mounted communication apparatus to perform switching using the switching unit in this way, it is possible to flexibly change the network configuration of a vehicle-mounted communication system.

It is preferable for the vehicle-mounted communication apparatus to include a control unit for controlling the switching by the switching unit, for the control unit to control the switching unit to switch to a connected state where the first communication path and the second communication path are connected, and to control, when an abnormality has been detected for communication performed by the communication unit, the switching unit to place the first communication path and the second communication path in the cut-off state.

In this aspect, the switching unit places the first communication path and the second communication path in the connected state so that the communication unit performs communication, and the switching unit switches the first communication path and the second communication path to the cut-off state when an abnormality has been detected during communication. By doing so, it is likely that the vehicle-mounted communication apparatus will dynamically disconnect and separate the networks when some kind of abnormality has occurred during communication, which prevents the influence of the abnormality from spreading over a wide area.

The vehicle-mounted communication apparatus preferably further includes a storage unit for storing a setting value relating to the switching by the switching unit; and a control unit for controlling the switching by the switching unit in keeping with the setting value stored in the storage unit.

In this aspect, the vehicle-mounted communication apparatus controls the switching by the switching unit in keeping with the setting value stored in the storage unit. By doing so, the network configuration of the vehicle can be changed as appropriate by writing the setting value in the storage unit for example during the manufacturing process of the vehicle.

The first communication path and the second communication path are preferably wiring patterns provided on a circuit board, the switching unit is preferably a circuit element that is detachably attached to the circuit board, and the first communication path and the second communication path are preferably placed in the connected state by attaching the circuit element.

In this aspect, the first communication path and the second communication path are realized by wiring patterns on a circuit board, and the switching unit is realized by a circuit element that can be detachably attached to the circuit board. By doing so, the network configuration of the vehicle can be changed as appropriate by attaching and detaching a circuit element during the manufacturing process of the vehicle, for example.

A vehicle-mounted communication system according to an aspect of the present disclosure includes: a vehicle-mounted communication apparatus including a first connection unit, a second connection unit, and a third connection unit to which communication lines provided in a vehicle are respectively connected, a communication unit configured to perform communication via the communication lines, a first communication path disposed between the first connection unit and the communication unit, a second communication path that directly connects the second connection unit and the third connection unit, and a switching unit for switching between a connected state where the first communication path and the second communication path are connected and a cut-off state where the first communication path and the second communication path are cut off, wherein a vehicle-mounted device installed at a front of the vehicle is connected via the communication lines to the first connection unit or the second connection unit, and a vehicle-mounted device installed at a rear of the vehicle is connected via the communication lines to the third connection unit.

In this aspect, a vehicle-mounted communication system is configured by connecting a vehicle-mounted device installed at the front of the vehicle via a communication line to the first connection unit or the second connection unit of the vehicle-mounted communication apparatus described earlier and connecting a vehicle-mounted device installed at the rear of the vehicle via a communication line to the third connection unit. Two communication lines in the front and rear of the vehicle, whose connectors would be directly connected to each other in a conventional vehicle, are connected to the second connection unit and the third connection unit of the vehicle-mounted communication apparatus and thereby connected via the second communication path of the vehicle-mounted communication apparatus. By doing so, it is possible to configure a communication network in a vehicle by connecting the two communication lines to which the vehicle-mounted devices are connected not directly to each other but via the vehicle-mounted communication apparatus so that vehicle-mounted devices installed in the front and rear of the vehicle can communicate with each other.

By placing the first communication path and the second communication path in the connected state using the switching unit, the vehicle-mounted communication apparatus makes it possible to transmit and receive signals relating to communication between three communication lines connected to the first connection unit, the second connection unit, and the third connection unit. As a result, it is possible for vehicle-mounted devices in the front and rear of the vehicle that are connected to the three communication lines to communicate with each other. Also, by placing the first communication path and the second communication path in the cut-off state using the switching unit, it becomes no longer possible to transmit and receive signals relating to communication between the communication line connected to the first connection unit and the two communication lines connected to the second connection unit and the third connection unit. By doing so, the vehicle-mounted communication apparatus can disconnect the networks in the vehicle. By configuring the vehicle-mounted communication apparatus to perform switching using the switching unit in this way it is possible to flexibly change the network configuration of a vehicle-mounted communication system.

It is preferable for a vehicle-mounted device for controlling brakes on front wheels of the vehicle to be connected via a communication line to the first connection unit and a vehicle-mounted device for controlling brakes on rear wheels of the vehicle to be connected via a communication line to the second connection unit or the third connection unit.

In this aspect, a vehicle-mounted device that controls the brakes of the front wheels of the vehicle is connected via a communication line to the first connection unit of the vehicle-mounted communication apparatus, and the vehicle-mounted device that controls the brakes of the rear wheels is connected via a communication line to the third connection unit. By switching the first communication path and the second communication path to the cut-off state using the switching unit, a vehicle network including the vehicle-mounted device that controls the brakes on the front wheels and a network including the vehicle-mounted device that controls the brakes on the rear wheels can be separated. By doing so, even if an abnormality or the like occurs on one of the networks, it is possible to prevent this abnormality from spreading to the other network. This means that it is likely that at least one of the front wheel brakes and the rear wheel brakes will operate.

It is preferable for a vehicle-mounted device for controlling a transmission of the vehicle to be connected via a communication line to the first connection unit; and a vehicle-mounted device for controlling a parking brake of the vehicle to be connected via a communication line to the second connection unit or the third connection unit.

In this aspect, a vehicle-mounted device that controls the transmission of the vehicle is connected via a communication line to the first connection unit of the vehicle-mounted communication apparatus, and the vehicle-mounted device that controls the parking brake is connected via a communication line to the second connection unit or the third connection unit. By switching the first communication path and the second communication path to the cut-off state using the switching unit, a vehicle network including the vehicle-mounted device that controls the transmission and a network including the vehicle-mounted device that controls the parking brake can be separated. By doing so, even if an abnormality or the like occurs on one of the networks, it is possible to prevent this abnormality from spreading to the other network, which means that the vehicle can be fixed in a stationary state using at least one of the transmission and the parking brake.

It is preferable for a first vehicle-mounted device for controlling a steering mechanism of the vehicle to be connected via a communication line to the first connection unit and a second vehicle-mounted device for controlling the steering mechanism to be connected via a communication line to the second connection unit or the third connection unit.

In this aspect, two devices, that is, a first vehicle-mounted device and a second vehicle-mounted device, that control the steering mechanism are installed in the vehicle, and it is possible to correctly operate the steering mechanism as long as either one of these vehicle-mounted devices operates. In this aspect, the first vehicle-mounted device is connected via a communication line to the first connection unit of the vehicle-mounted communication apparatus, and the second vehicle-mounted device is connected via a communication line to the second connection unit or the third connection unit. By switching the first communication path and the second communication path to the cut-off state using the switching unit, a vehicle network including the first vehicle-mounted device and a network including the second vehicle-mounted device can be separated. By doing so, even if an abnormality or the like occurs on one of the networks, it is possible to prevent this abnormality from spreading to the other network, which means that the steering mechanism can be controlled using at least one of the first vehicle-mounted device and the second vehicle-mounted device.

It is preferable for a first vehicle-mounted device that performs control relating to autonomous driving of the vehicle to be connected via a communication line to the first connection unit and a second vehicle-mounted device that performs control relating to autonomous driving of the vehicle to be connected via a communication line to the second connection unit or the third connection unit.

In this aspect, two devices, that is, a first vehicle-mounted device and a second vehicle-mounted device, that perform control relating to autonomous driving are installed in the vehicle, and it is possible to correctly perform autonomous driving as long as either one of these vehicle-mounted devices operates. In this aspect, the first vehicle-mounted device is connected via a communication line to the first connection unit of the vehicle-mounted communication apparatus, and the second vehicle-mounted device is connected via a communication line to the second connection unit or the third connection unit. By switching the first communication path and the second communication path to the cut-off state using the switching unit, a vehicle network including the first vehicle-mounted device and a network including the second vehicle-mounted device can be separated. By doing so, even if an abnormality or the like occurs on one of the networks, it is possible to prevent this abnormality from spreading to the other network, which means that autonomous driving of the vehicle can be performed using at least one of the first vehicle-mounted device and the second vehicle-mounted device.

It is preferable for a vehicle-mounted device for controlling a sensor for detecting objects present in a surrounding area of the vehicle to be connected via a communication line to the first connection unit and a vehicle-mounted device for controlling a camera that captures images of a surrounding area of the vehicle to be connected via a communication line to the second connection unit or the third connection unit.

In this aspect, a sensor for detecting objects present in the surrounding area of the vehicle and a camera for capturing images in the surrounding area of the vehicle are installed in the vehicle as one example to monitor the front or the rear of the vehicle. In this aspect, a vehicle-mounted device for controlling the sensor is connected via a communication line to the first connection unit of the vehicle-mounted communication apparatus, and a vehicle-mounted device for controlling the camera is connected via a communication line to the second connection unit or the third connection unit. By switching the first communication path and the second communication path to the cut-off state using the switching unit, a vehicle network including the first vehicle-mounted device and a network including the second vehicle-mounted device can be separated. By doing so, even if an abnormality or the like occurs on one of the networks, it is possible to prevent this abnormality from spreading to the other network, which means that it is possible to monitor the periphery of the vehicle using at least one of the sensor and the camera.

It is preferable for a vehicle-mounted device for performing display control of a meter provided in an interior of the vehicle to be connected via a communication line to the first connection unit and a car navigation apparatus to be connected via a communication line to the second connection unit or the third connection unit.

In this aspect, a vehicle-mounted device for performing display control of a meter is connected via a communication line to the first connection unit of the vehicle-mounted communication apparatus, and a car navigation apparatus is connected via a communication line to the second connection unit or the third connection unit. By switching the first communication path and the second communication path to the cut-off state using the switching unit, a vehicle network including the vehicle-mounted device for performing display control of the meter and a network including the car navigation apparatus can be separated. By doing so, even if an abnormality or the like occurs on one of the networks, it is possible to prevent this abnormality from spreading to the other network. This means that this vehicle-mounted communication system can use the display function of the meter or the display function of the car navigation apparatus to display messages and the like to the driver.

Specific embodiments of a vehicle-mounted communication system according to embodiments of the present disclosure will now be described with reference to the attached drawings. Note that the present disclosure is not limited to the illustrated configurations and is instead indicated by the range of the patent claims and intended to include all changes within the meaning and scope of the patent claims and their equivalents.

### First Embodiment

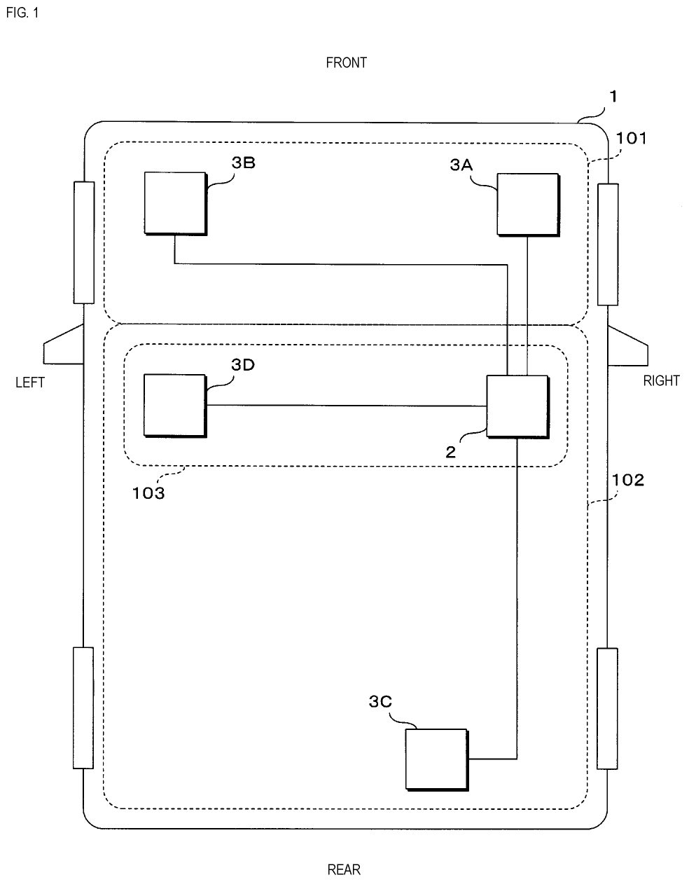

FIG. 1 is a schematic diagram for describing the configuration of a vehicle-mounted communication system according to an embodiment of the present disclosure. The vehicle-mounted communication system according to the present embodiment is a system in which a vehicle 1 is equipped with a plurality of ECUs 2, and 3A to 3D, with this plurality of ECUs 2 and 3A to 3D communicating via communication lines. Each of the ECUs 2 and 3A to 3D is installed at an appropriate location in the vehicle 1, and performs various processing, such as control processing relating to the running of the vehicle 1, information processing for collecting information regarding the surrounding area of the vehicle 1, and processing for providing information to the user.

In the present embodiment, the area inside the vehicle 1 in which devices such as the ECUs 2 and 3A to 3D and communication lines can be installed is roughly divided into a front area 101 and a rear area 102. As examples, the front area 101 is an area corresponding to the engine room and the rear area 102 is an area in the vehicle interior located behind the engine room. Also in the present embodiment, a specific area included in the rear area 102, as one example an area where devices relating to the instrument panel are installed, is treated as an “instrument panel area 103”. Note that these area names, area positions, area sizes, and the like are mere examples, and the present disclosure is not limited to such.

In the vehicle-mounted communication system according to the present embodiment, the ECUs 3A and 3B are installed in the front area 101, the ECU 3C is installed in the rear area 102, and the ECU 3D is installed in the instrument panel area 103. Although the ECU 2 may be installed in any of the front area 101, the rear area 102, and the instrument panel area 103, the ECU 2 is mounted in the instrument panel area 103 in the illustrated example. The ECUs 3A to 3D are connected to the ECU 2 via individual communication lines. Each of these communication lines is a so-called “wire harness” where one or a plurality of electric wires that are required for communication are bundled together, with connectors provided at both ends of each wire harness for connecting to devices. Note that a communication line may have branches, and in this case, three or more devices can be connected to one communication line.

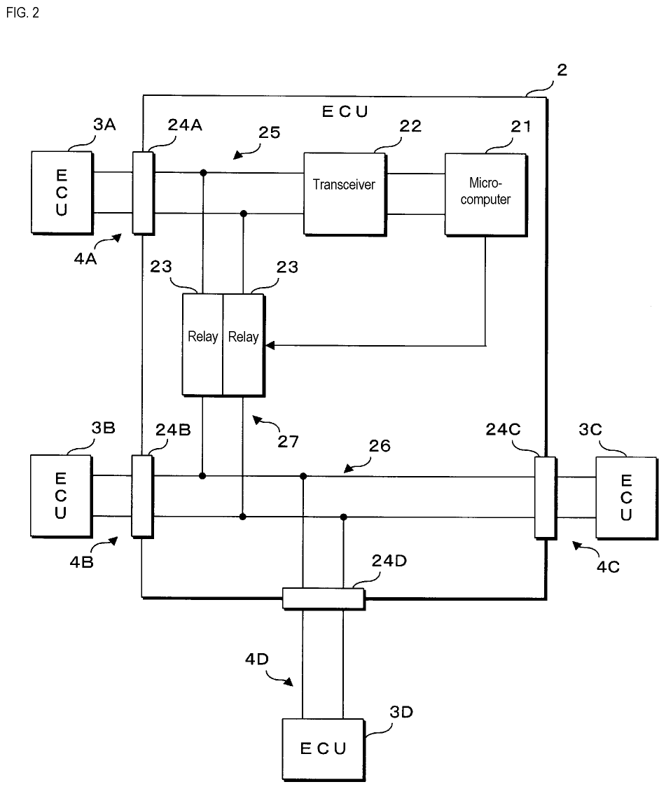

FIG. 2 is a block diagram depicting the configuration of the ECU 2 according to the first embodiment. The ECU 2 according to the first embodiment includes a microcomputer (or “control unit”) 21, a transceiver (or “communication unit”) 22, a relay (or “switching unit”) 23, connectors (or “connection units”) 24A to 24D, and the like. The microcomputer 21 is configured using an IC (Integrated Circuit), such as a microcomputer or a microcontroller. As one example, the microcomputer 21 reads out and executes a program stored in a non-volatile memory (not illustrated) provided inside or outside the microcomputer 21 to perform computational processing that controls the operations of each component of the ECU 2.

The transceiver 22 performs transmission and reception of messages to and from the other ECUs 3A to 3D by performing signal processing relating to communication according to a predetermined communication protocol. In the present embodiment, the transceiver 22 performs communication according to CAN (Controller Area Network) communication protocol. CAN is a communication protocol that performs communication via two communication lines called “CAN-HI” and “CAN-LO”. In FIG. 2, the communication lines and communication paths that are present inside the ECU 2 are illustrated using two lines. The transceiver 22 transmits a message by outputting a transmission message provided as digital data from the microcomputer 21 as an electrical signal that conforms to CAN communication protocol. The transceiver 22 detects an electric signal relating to communication based on the potential of a communication line or communication path, and converts this electric signal into digital data that is passed to the microcomputer 21 as a received message. Note that the communication protocol used by the transceiver 22 is not limited to CAN, and as other examples may be a communication protocol such as CAN-FD (CAN with Flexible Data rate), CAN-XL, Ethernet, LIN (Local Interconnect Network) or CXPI (Clock Extension Peripheral Interface). The vehicle-mounted communication system according to the present embodiment is assumed to have a network configuration where a plurality of communication apparatuses share communication lines, that is, a so-called “bus-type” network configuration.

The four connectors 24A to 24D are mated with connectors (not illustrated) provided at the ends of the communication lines 4A to 4D to electrically connect the communication lines with the wiring, circuits, and the like inside the ECU 2. In the present embodiment, the first connector 24A is connected via the communication line 4A to the ECU 3A installed in the front area 101 of the vehicle 1. The second connector 24B is connected via the communication line 4B to the ECU 3B installed in the front area 101. The third connector 24C is connected via the communication line 4C to the ECU 3C installed in the rear area 102. The fourth connector 24D is connected via the communication line 4D to the ECU 3D installed in the instrument panel area 103.

The ECU 2 according to the present embodiment is configured by housing a circuit board, on which circuit components such as the microcomputer 21 and the transceiver 22 are mounted, in a case made of synthetic resin, for example. The connectors 24A to 24D are electrically connected to and fixed to the circuit board, and are partially exposed to the outside through openings formed in side surfaces or the like of the case of the ECU 2. The microcomputer 21, the transceiver 22, and the connectors 24A to 24D mounted on the circuit board are electrically connected via wiring patterns formed on the circuit board. In the present embodiment, the wiring pattern that connects between the transceiver 22 and the first connector 24A is referred to as the “first communication path 25”. A wiring pattern that directly connects the second to fourth connectors 24B to 24D is referred to as the “second communication path 26”. Note that as one example, a filter circuit or the like for removing signal noise may be interposed on the second communication path 26 that directly connects the second to fourth connectors 24B to 24D.

The ECU 2 according to the present embodiment is also provided with a third communication path 27 that electrically connects the first communication path 25 and the second communication path 26 as a wiring pattern on the circuit board. Relays 23 are provided midway on the third communication path 27, and switching between a conductive state and a cut-off state of the relays 23 is controlled based on a signal provided from the microcomputer 21. Although the relays in this example are circuit components such as electromagnetic relays or solid state relays, it is also possible to use semiconductor switches or the like, such as field effect transistors or a MOS (Metal Oxide Semiconductor) transistors.

When the relays 23 are in the conductive state, the first communication path 25 and the second communication path 26 are electrically connected via the third communication path 27. In this state, the transceiver 22 of the ECU 2 and the ECUs 3A to 3D become connected by sharing one communication line, and are capable of communicating with each other. On the other hand, when the relays 23 are in the cut-off state, the first communication path 25 and the second communication path 26 are not electrically connected and become separated. In this state, although communication is possible between the transceiver 22 of the ECU 2 and the ECU 3A, and communication is possible between the ECUs 3B to 3D, communication is not possible between the ECUs 2 and 3A and the ECUs 3B to 3D.

The microcomputer 21 of the ECU 2 according to the present embodiment places the relays 23 in the conductive state in an initial state, for example, and communicates with the ECUs 3A to 3D using the transceiver 22. As one example, the initial state is the state immediately after the ignition switch of the vehicle 1 is switched from an off state to an on state and the power to the ECU 2 is turned on. After this, the microcomputer 21 communicates with the other ECUs 3A to 3D using the transceiver 22 and performs processing for detecting communication abnormalities. As examples, the microcomputer 21 can determine that an abnormality has occurred when the transceiver 22 has received an error frame in the CAN communication protocol a predetermined number of times or more, when a message appended with an undefined CAN-ID has been received, when a message has been received at a timing that differs to a predetermined period, when transmission of a message has continuously failed for a predetermined number of attempts or more, or when the amount of communication has exceeded a threshold. Note that these abnormalities relating to communication are mere examples to which the present disclosure is not limited. The situations where the microcomputer 21 determines that a communication abnormality has occurred may be decided as appropriate in keeping with the configuration of the vehicle 1 or the vehicle-mounted communication system.

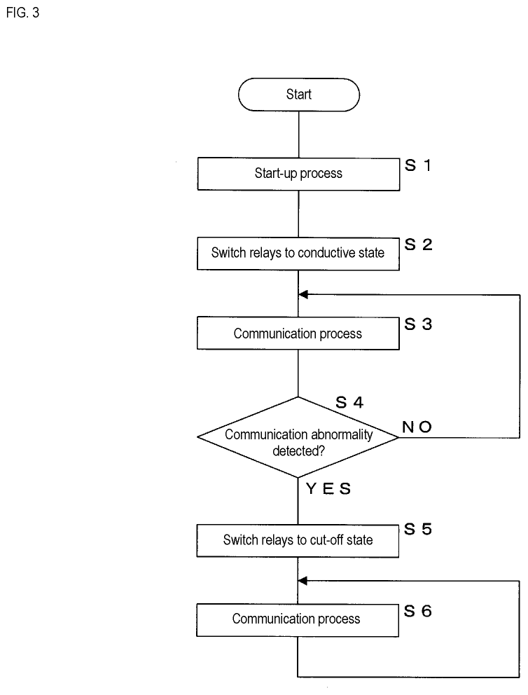

FIG. 3 is a flowchart depicting the procedure of processing performed by the ECU 2 according to the first embodiment. The microcomputer 21 of the ECU 2 according to the first embodiment performs predetermined start-up processing when, for example, the ignition switch of the vehicle 1 is turned on and the power of the ECU 2 is turned on (step S1). After the start-up processing ends, the microcomputer 21 switches the relays 23 to the conductive state (step S2). Note that if the relays 23 are in the conductive state in the initial state, that is, if the relays 23 are so-called “normally-on” relays, the microcomputer 21 does not need to perform switching of the relays 23 in step S2.

The microcomputer 21 performs communication processing with the other ECUs 3A to 3D using the transceiver 22 (step S3). The microcomputer 21 determines whether any kind of abnormality has been detected during the communication processing (step S4). If no abnormality has been detected (S4: NO), the microcomputer 21 returns the processing to step S3 and continues the communication processing. If an abnormality has been detected (S4: YES), the microcomputer 21 switches the relays 23 to the cut-off state (step S5). After this, the microcomputer 21 continues the communication processing with the ECU 3A using the transceiver 22 (step S6). Note that the microcomputer 21 may stop the communication processing if communication with the ECU 3A cannot be performed due to the abnormality detected in step S4.

When an abnormality has occurred during communication, the ECU 2 according to the first embodiment performs switching to a state where the first communication path 25 and the second communication path 26 are cut-off by switching the relays 23 from the conductive state to the cut-off state. By doing so, the ECU 2 can separate between a first network including the transceiver 22 and the ECU 3A that are connected to the first communication path 25 and a second network including the ECUs 3B to 3D that are connected to the second communication path 26. Accordingly the ECU 2 can prevent a communication abnormality caused by one network from spreading to the other network. By using this ability and appropriately selecting the vehicle-mounted devices connected to the first network and the vehicle-mounted devices connected to the second network, there is potential to achieve redundancy for the functions of the vehicle 1 realized by such vehicle-mounted devices.

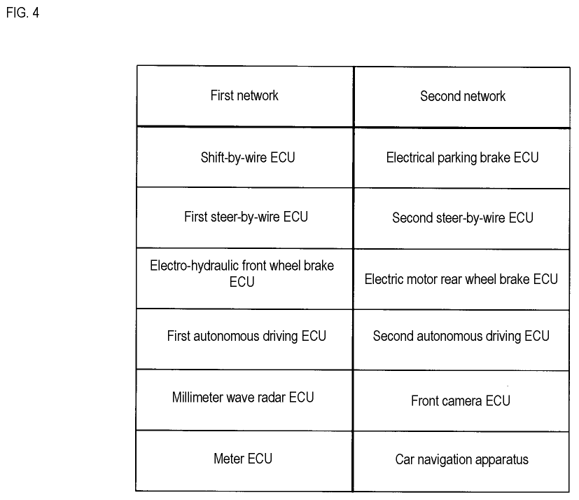

FIG. 4 is a table indicating examples of vehicle-mounted devices included in the first network and the second network. In the vehicle-mounted communication system according to the present embodiment, it is possible to separate the communication network installed in the vehicle 1 into two by switching the relays 23 provided in the ECU 2 between the conductive state and the cut-off state. Hereinafter, a network including one or a plurality of the ECUs 3A connected via the communication line 4A to the first connector 24A of the ECU 2, and also the transceiver 22 of the ECU 2 and the first communication path 25 is referred to as the “first network”. A network including one or a plurality of the ECUs 3B to 3D connected via the communication lines 4B to 4D to the second connectors 24B to 24D of the ECU 2 and the second communication path 26 of the ECU 2 is referred to as the “second network”.

By normally placing the relays 23 in the conductive state, the ECU 2 performs communication as a single network with the first network and the second network in a connected state. When an abnormality has been detected during communication, the ECU 2 places the relays 23 in the cut-off state to separate and cut-off the first network and the second network and thereby prevents the communication abnormality from spreading over a wide area. The vehicle-mounted devices to be connected to the first network and the second network are decided as appropriate by the designer of the vehicle 1 or the like in keeping with the types, functions, installed positions, and the like of the various apparatuses installed in the vehicle 1. However, it is preferable to split vehicle-mounted devices with similar functions or complementary functions between the first network and the second network.

As one example, it would be conceivable to connect a shift-by-wire ECU that performs shift-by-wire control of the vehicle 1 to the first network and to connect an electrical parking brake ECU that controls the electrical parking brake of the vehicle 1 to the second network. Although not described in detail here, the expression “shift-by-wire” refers to electric control of the transmission of the vehicle 1. As one example, by setting the transmission to the “P (parking)” state, the vehicle 1 can be held and kept stationary. An electrical parking brake electrically controls the parking brake of the vehicle 1, and likewise keeps the vehicle 1 stationary. By distributing vehicle-mounted devices with a function of keeping the vehicle 1 stationary between the first network and the second network and thereby providing redundancy, even if an abnormality has occurred on one of the networks, it is highly likely that the function of keeping the vehicle 1 stationary will be achieved by operating a vehicle-mounted device connected to the other network.

As another example, it would be conceivable for the vehicle 1 to be equipped with two steer-by-wire ECUs that perform a steer-by-wire function that electrically controls the steering mechanism, with the first steer-by-wire ECU connected to the first network and the second steer-by-wire ECU connected to the second network. By distributing the steer-by-wire ECUs responsible for the steering function of the vehicle 1 to the first network and the second network and thereby providing redundancy even if an abnormality has occurred on one of the networks, it is highly likely that the steering function of the vehicle 1 will be achieved by the steer-by-wire ECU connected to the other network.

As another example, it would be conceivable to connect an electro-hydraulic front wheel brake ECU that controls the brakes of the front wheels of the vehicle 1 to the first network and to connect an electric motor rear wheel brake ECU that controls the brakes of the rear wheels of the vehicle 1 to the second network. By distributing the vehicle-mounted devices responsible for the braking function of the vehicle 1 between the first network and the second network and thereby providing redundancy, even if an abnormality occurs on one of the networks, it is highly likely that a brake function of the vehicle 1 will be achieved by a vehicle-mounted device connected to the other network.

As another example, it would be conceivable for two autonomous driving ECUs that perform control related to autonomous driving of the vehicle 1 to be provided in the vehicle 1, with a first autonomous driving ECU connected to the first network and the second autonomous driving ECU connected to the second network. By distributing the autonomous driving ECUs responsible for functions related to autonomous driving of the vehicle 1 between the first network and the second network and thereby providing redundancy, even if an abnormality occurs on one of the networks, it is highly likely that an autonomous driving function of the vehicle 1 will be achieved by the autonomous driving ECU connected to the other network.

As another example, it would be conceivable for a millimeter wave radar ECU for controlling the millimeter wave radar to be connected to the first network and a front camera ECU for controlling a front camera of the vehicle 1 to be connected to the second network. The millimeter wave radar is used as a sensor that detects obstacles and the like present in the surrounding area of the vehicle 1 by emitting radio waves in a frequency band of 30 GHz to 300 GHz and detecting the reflected waves. The front camera captures images of a space in front of the vehicle 1, for example, with the front camera ECU performing image processing to detect obstacles and the like appearing in the captured images. By distributing the vehicle-mounted devices that perform a function of detecting obstacles and the like present in the surrounding area of the vehicle 1 between the first network and the second network and thereby providing redundancy, even if an abnormality occurs on one of the networks, it is highly likely that a function of detecting obstacles and the like present in the surrounding area of the vehicle 1 will be achieved by a vehicle-mounted device connected to the other network.

As another example, it would be conceivable to connect a meter ECU that controls the displaying of meters of the vehicle 1 to the first network and to connect a car navigation apparatus of the vehicle 1 to the second network. The meters and a car navigation apparatus installed in the vehicle 1 are both vehicle-mounted devices that form an interface with a user, such as a driver, and both have a function of displaying information to the user. By distributing the vehicle-mounted devices responsible for functions that display information to the user between the first network and the second network and thereby providing redundancy, even if an abnormality occurs on one of the networks, it is highly likely that a function of displaying information to the user will be achieved by the vehicle-mounted device connected to the other network.

Note that the vehicle-mounted devices depicted in FIG. 4 and the correspondence between the networks and the vehicle-mounted devices are mere examples to which the present disclosure is not limited, and various vehicle-mounted devices may be connected to the first network and the second network. The connection relationships depicted in FIG. 4 may also be reversed. As one example, the electrical parking brake ECU may be connected to the first network and the shift-by-wire ECU may be connected to the second network. However, in FIG. 4, vehicle-mounted devices installed in the front area 101 of the vehicle 1 and connected to the first connector 24A of the ECU 2 are included in the first network. Likewise, vehicle-mounted devices that are installed in the rear area 102 or the instrument panel area 103 of the vehicle 1 and connected to the second to fourth connectors 24B to 24D of the ECU 2 are included in the second network.

In the vehicle-mounted communication system according to the first embodiment with the configuration described above, the ECU 2 installed in the vehicle 1 includes the first connector 24A to the fourth connector 24D for connecting the communication lines 4A to 4D, respectively, and the transceiver 22 for communicating with the ECUs 3A to 3D that are connected to these communication lines 4A to 4D. The ECU 2 is internally provided with the first communication path 25 disposed between the first connector 24A and the transceiver 22 and the second communication path 26 that directly connects between the second to fourth connectors 24B to 24D. The ECU 2 is equipped with the relays 23 that switch between a state where the first communication path 25 and the second communication path 26 are connected and a cut-off state.

Two communication lines whose connectors would be directly connected to each other in a conventional vehicle are instead connected via the second communication path 26 by connecting such communication lines to the second to fourth connectors 24B to 24D of the ECU 2. By doing so, it is possible to construct a vehicle network by connecting communication lines via the ECU 2 without directly connecting the communication lines themselves.

When the ECU 2 places the first communication path 25 and the second communication path 26 in the connected state using the relays 23, it becomes possible for signals relating to communication to be sent and received between the plurality of communication lines 4A to 4D connected to the first to fourth connectors 24A to 24D. By doing so, it is possible for the ECUs 3A to 3D connected to the communication lines 4A to 4D to communicate. When the ECU 2 cuts off the connection between the first communication path 25 and the second communication path 26 using the relays 23, it is no longer possible to transmit and receive signals relating to communication between the communication line 4A connected to the first connector 24A and the communication lines 4B to 4D connected to the second to fourth connectors 24B to 24D. By configuring the ECU 2 to perform switching control using the relays 23 in this way, it is possible to flexibly change the network configuration of the vehicle-mounted communication system.

The ECU 2 according to the present embodiment sets the relays 23 in the conductive state to place the first communication path 25 and the second communication path 26 in the connected state and performs communication using the transceiver 22. When an abnormality has been detected during the communication, the relays 23 are switched to the cut-off state to cut off the connection between the first communication path 25 and the second communication path 26. By doing so, when some kind of abnormality has occurred in the communication, the ECU 2 will dynamically disconnect and separate the networks, making it likely that the influence of the abnormality will be prevented from spreading over a wide area.

Note that although the ECU 2 according to the present embodiment is configured with four connectors from the first connector 24A to the fourth connector 24D, the number of connectors is not limited to four and may be three, or five or more. A plurality of connectors may be connected to the first communication path 25. It is sufficient for at least two connectors to be connected (directly connected) to the second communication path 26. Also, although the vehicle-mounted communication system according to the present embodiment has the vehicle 1 divided into three areas, the front area 101, the rear area 102, and the instrument panel area 103, and defines the correspondence between such areas and the first to fourth connectors 24A to 24D of the ECU 2, the present disclosure is not limited to this and the area inside the vehicle 1 may be divided into two or fewer or four or more areas, or may not be divided into areas.

### Second Embodiment

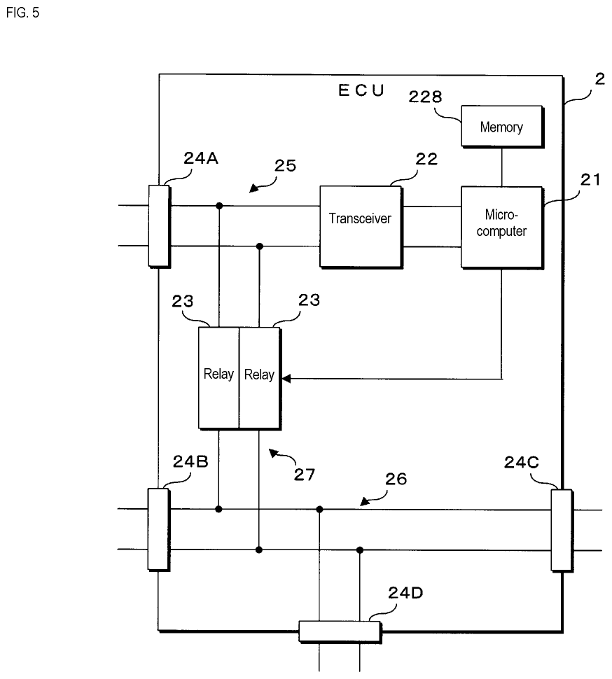

FIG. 5 is a block diagram depicting the configuration of an ECU 2 according to a second embodiment. The ECU 2 according to the second embodiment includes a memory 228 that stores a setting value that determines whether the relays 23 are to be placed in the conductive state or the cut-off state. The memory 228 is configured using a non-volatile memory element whose data is rewritable, such as an EEPROM (Electrically Erasable Programmable Read Only Memory) or flash memory. Note that the memory 228 may be memory embedded in the microcomputer 21. Also, the memory 228 may store data, programs, or the like aside from the setting value relating to the relays 23.

The microcomputer 21 of the ECU 2 according to the second embodiment reads out the setting value stored in the memory 228 when for example the ignition switch of the vehicle 1 is switched from the off state to the on state and the power of the ECU 2 is turned on. The microcomputer 21 performs switching control of the relays 23 by outputting a signal to set the relays 23 in the conductive state or the cut-off state in keeping with the read setting value. The ECU 2 according to the second embodiment does not perform dynamic switching control of the relays 23 in keeping with an abnormality in communication, for example, and instead performs static switching control of the relays 23 according to the setting value stored in the memory 228.

Note that writing of the setting value relating to the switching state of the relays 23 into the memory 228 may be performed during the manufacturing process of the ECU 2 or the vehicle 1, for example. The setting value stored in the memory 228 can also be changed (overwritten) for example by a dealer of the vehicle 1 or a maintenance center. As examples, the designer of the vehicle 1, the designer of the vehicle-mounted communication system, the manufacturer of the vehicle 1, or a mechanic of the vehicle 1 can appropriately determine whether the relays 23 should be placed in the conductive state or the cut-off state. As one example, it is possible to determine whether the relays 23 are to be placed in the conductive state or the cut-off state in keeping with the number of vehicle-mounted devices respectively connected to the first network and the second network. CAN communication protocol defines an upper limit for the number of vehicle-mounted devices that can be connected to a communication line, and when the number of vehicle-mounted devices installed in the vehicle 1 exceeds this upper limit, it is likely that the upper limit can be satisfied by setting the relays 23 in the cut-off state to separate the network into two networks.

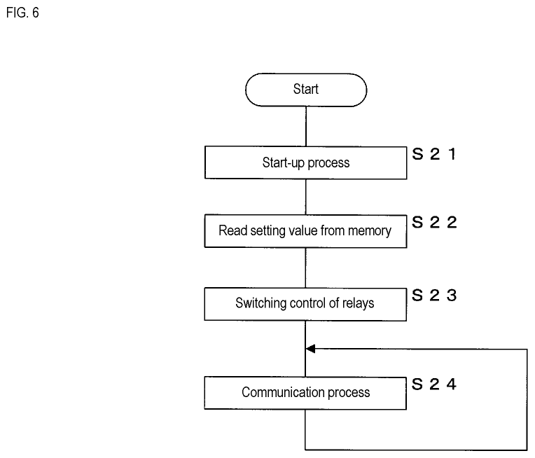

FIG. 6 is a flowchart depicting the procedure of processing performed by the ECU 2 according to the second embodiment. The microcomputer 21 of the ECU 2 according to the second embodiment performs a predetermined start-up processing when, for example, the ignition switch of the vehicle 1 is turned on and the power of the ECU 2 is turned on (step S21). After the startup processing is completed, the microcomputer 21 reads out the setting value stored in the memory 228 (step S22). The microcomputer 21 determines either the conductive state or the cut-off state in keeping with the setting value read in step S22, and performs control to switch the state of the relays 23 so as to become the determined state (step S23). After this, the microcomputer 21 continues the communication processing by the transceiver 22 (step S24).

In the ECU 2 according to the second embodiment with the configuration described above, the microcomputer 21 performs switching control using the relays 23 in keeping with the setting value stored in the memory 228. By doing so, the network configuration of the vehicle 1 can be appropriately changed by writing the setting value into the memory 228 during the manufacturing process of the vehicle 1, for example.

Since the other configurations of the vehicle-mounted communication system according to the second embodiment are the same as the vehicle-mounted communication system according to the first embodiment, parts that are the same have been assigned the same reference numerals and detailed description thereof is omitted.

### Third Embodiment

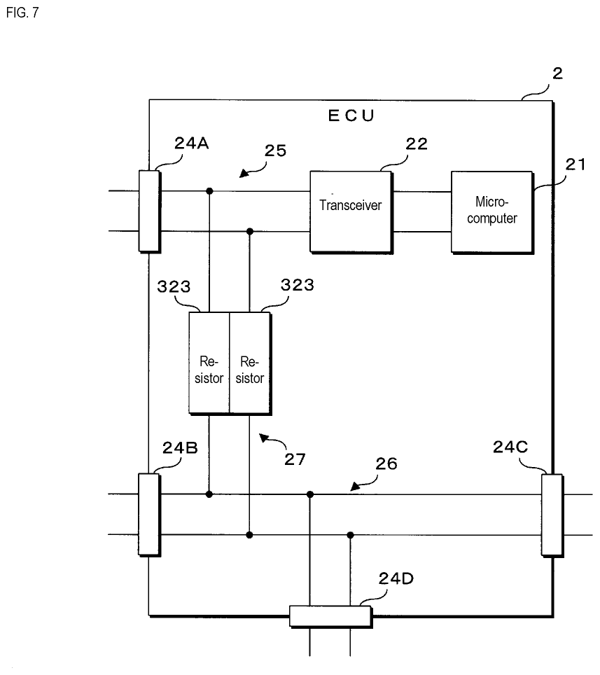

FIG. 7 is a block diagram depicting the configuration of the ECU 2 according to the third embodiment. The ECU 2 according to the third embodiment includes resistors 323 in place of the relays 23 in the ECU 2 according to the first embodiment. The resistors 232 are provided midway on a third communication path 27 connecting the first communication path 25 and the second communication path 26. As one example, the resistors 232 are resistors with a resistance value of 0Ω, and are circuit components sometimes referred to as “jumpers”. The microcomputer 21 of the ECU 2 according to the third embodiment does not perform switching control or the like for the resistors 232 provided in place of the relays 23.

The resistors 232 can be detachably attached to the circuit board on which the first communication path 25 and the second communication path 26 are formed as wiring patterns. By attaching the resistors 232 to the circuit board, the first communication path 25 and the second communication path 26 become electrically connected via the resistors 232. By removing the resistors 232 from the circuit board, the first communication path 25 and the second communication path 26 are electrically disconnected (that is, cut off). This means that the ECU 2 according to the third embodiment uses attachment or non-attachment of the resistors 232 as a setting for connecting or disconnecting the first communication path 25 and the second communication path 26, and by doing so can obtain the same effects as the ECU 2 according to the second embodiment.

Note that attachment or removal of the resistors 232 to and from the circuit board of the ECU 2 may be performed for example during the manufacturing process of the ECU 2 or the vehicle 1, or as another example may be performed at a dealer of the vehicle 1, a maintenance center, or the like. The decision as to whether to attach the resistors 232, that is, whether to connect or cut off the first communication path 25 and the second communication path 26 can be made as appropriate for example by the designer of the vehicle 1, the designer of the vehicle-mounted communication system, the manufacturer of the vehicle 1, or a mechanic of the vehicle 1.

The ECU 2 according to the third embodiment with the configuration described above is configured so that the first communication path 25 and the second communication path 26 are wiring patterns on the circuit board and the first communication path 25 and the second communication path 26 can be switched between a conductive state and a cut-off state using circuit elements such as the resistors 232 that can be detachably attached to the circuit board. Accordingly by attaching or detaching the resistors 232 during the manufacturing process of the vehicle 1 for example, the network configuration of the vehicle 1 can be changed as appropriate.

Note that although the resistors 232 are detachably attached to the circuit board of the ECU 2 in this third embodiment, the configuration is not limited to this and a circuit element aside from the resistors 232 may be detachably attached.

Since the other configurations of the vehicle-mounted communication system according to the third embodiment are the same as the vehicle-mounted communication systems according to the first and second embodiments, parts that are the same have been assigned the same reference numerals and detailed description thereof is omitted.

### Fourth Embodiment

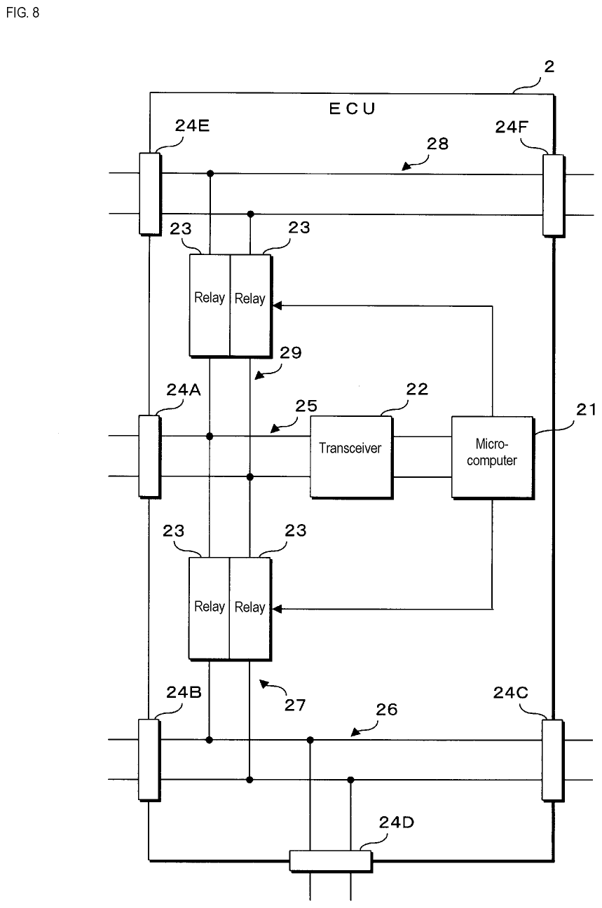

FIG. 8 is a block diagram depicting the configuration of an ECU 2 according to a fourth embodiment. The ECU 2 according to the fourth embodiment is configured by adding a fifth connector 24E and a sixth connector 24F to the ECU 2 according to the first embodiment. The fifth connector 24E and the sixth connector 24F are directly connected via a fourth communication path 28 provided as a wiring pattern on the circuit board inside the ECU 2. In the ECU 2 according to the fourth embodiment, a fifth communication path 29 that electrically connects the first communication path 25 and the fourth communication path 28 is also provided on the circuit board. The relays 23 are provided midway on the fifth communication path 29, and switching between the conductive state and the cut-off state of the relays 23 is controlled based on a signal provided from the microcomputer 21.

In the ECU 2 according to the fourth embodiment, the relays 23 provided between the first communication path 25 and the second communication path 26 and the relays 23 provided between the first communication path 25 and the fourth communication path 28 are subjected to individual switching control by the microcomputer 21, so that the network in the vehicle 1 can be collectively treated as a single network, and can also be separated as appropriate into two or three networks. The ECU 2 may perform such switching of the relays 23 dynamically or statically.

Note that the ECU 2 may be configured to include a larger number of connectors, relays, and the like to separate the network in the vehicle into four or more networks.

Since the other configurations of the vehicle-mounted communication system according to the fourth embodiment are the same as the vehicle-mounted communication systems according to the first to third embodiments, parts that are the same have been assigned the same reference numerals and detailed description thereof is omitted.

The vehicle-mounted communication apparatus is equipped with a computer that includes a microprocessor, ROM, RAM, and the like. A computation processing unit, such as a microprocessor, may read out and execute a computer program including part or all of the steps in the sequence diagrams or flowcharts such as FIG. 3 and FIG. 6 from a storage unit such as ROM or RAM. A computer program for this plurality of apparatuses can be installed from an external server apparatus or the like. The computer program is also distributed having been stored on a recording medium such as a CD-ROM, DVD-ROM, or a semiconductor memory.

All features of the embodiments disclosed here are exemplary and should not be regarded as limitations on the present disclosure. The scope of the present disclosure is indicated by the range of the patent claims, not the description given above, and is intended to include all changes within the meaning and scope of the patent claims and their equivalents.

1. A vehicle-mounted communication apparatus comprising:
a first connection unit, a second connection unit, and a third connection unit to which communication lines provided in a vehicle are respectively connected;
a communication unit configured to perform communication via the communication lines;
a first communication path disposed between the first connection unit and the communication unit;
a second communication path that directly connects the second connection unit and the third connection unit; and
a switching unit for switching between a connected state where the first communication path and the second communication path are connected and a cut-off state where the first communication path and the second communication path are cut off.

2. The vehicle-mounted communication apparatus according to claim 1,
further comprising a control unit for controlling the switching by the switching unit,
wherein the control unit controls the switching unit to switch to a connected state where the first communication path and the second communication path are connected, and
controls, when an abnormality has been detected for communication performed by the communication unit, the switching unit to place the first communication path and the second communication path in the cut-off state.

3. The vehicle-mounted communication apparatus according to claim 1,
further comprising a storage unit for storing a setting value relating to the switching by the switching unit; and
a control unit for controlling the switching by the switching unit in keeping with the setting value stored in the storage unit.

4. The vehicle-mounted communication apparatus according to claim 1,
wherein the first communication path and the second communication path are wiring patterns provided on a circuit board,
the switching unit is a circuit element that is detachably attached to the circuit board, and
the first communication path and the second communication path are placed in the connected state by attaching the circuit element.

5. A vehicle-mounted communication system comprising:
a vehicle-mounted communication apparatus including a first connection unit, a second connection unit, and a third connection unit to which communication lines provided in a vehicle are respectively connected, a communication unit configured to perform communication via the communication lines, a first communication path disposed between the first connection unit and the communication unit, a second communication path that directly connects the second connection unit and the third connection unit, and a switching unit for switching between a connected state where the first communication path and the second communication path are connected and a cut-off state where the first communication path and the second communication path are cut off,
wherein a vehicle-mounted device installed at a front of the vehicle is connected via the communication lines to the first connection unit or the second connection unit, and
a vehicle-mounted device installed at a rear of the vehicle is connected via the communication lines to the third connection unit.

6. The vehicle-mounted communication system according to claim 5,
wherein a vehicle-mounted device for controlling brakes on front wheels of the vehicle is connected via a communication line to the first connection unit; and
a vehicle-mounted device for controlling brakes on rear wheels of the vehicle is connected via a communication line to the second connection unit or the third connection unit.

7. The vehicle-mounted communication system according to claim 5,
wherein a vehicle-mounted device for controlling a transmission of the vehicle is connected via a communication line to the first connection unit; and
a vehicle-mounted device for controlling a parking brake of the vehicle is connected via a communication line to the second connection unit or the third connection unit.

8. The vehicle-mounted communication system according to claim 5,
wherein a first vehicle-mounted device for controlling a steering mechanism of the vehicle is connected via a communication line to the first connection unit, and
a second vehicle-mounted device for controlling the steering mechanism is connected via a communication line to the second connection unit or the third connection unit.

9. The vehicle-mounted communication system according to claim 5,
wherein a first vehicle-mounted device that performs control relating to autonomous driving of the vehicle is connected via a communication line to the first connection unit, and
a second vehicle-mounted device that performs control relating to autonomous driving of the vehicle is connected via a communication line to the second connection unit or the third connection unit.

10. The vehicle-mounted communication system according to claim 5,
wherein a vehicle-mounted device for controlling a sensor for detecting objects present in a surrounding area of the vehicle is connected via a communication line to the first connection unit, and
a vehicle-mounted device for controlling a camera that captures images of a surrounding area of the vehicle is connected via a communication line to the second connection unit or the third connection unit.

11. The vehicle-mounted communication system according to claim 5,
wherein a vehicle-mounted device for performing display control of a meter provided in an interior of the vehicle is connected via a communication line to the first connection unit, and
a car navigation apparatus is connected via a communication line to the second connection unit or the third connection unit.
